(19) United States
(12) Patent Application Publication
(10) Pub. No.: US 2015/0381629 A1
(43) Pub. Date: Dec. 31, 2015

(54) Crowd Sourced Access Approvals

(71) Applicant: INTERNATIONAL BUSINESS MACHINES CORPORATION, ARMONK, NY (US)

(72) Inventors: Patrick J. O'Sullivan, Dublin (IE); Jeffrey B. Sloyer, Cary, NC (US); Edith H. Stern, Yorktown Heights, NY (US); Barry E. Willner, Briarcliff Manor, NY (US)

(21) Appl. No.: 14/315,632

(22) Filed: Jun. 26, 2014

(51) Int. Cl. H04L 29/06; G06F 17/30

(52) U.S. Cl. CPC H04L 63/101; G06F 17/30864; H04L 63/102; H04L 63/104

(57) ABSTRACT

An approach is provided in which a crowd source access manager receives a user request from a requestor to access a resource and determines a set of candidate approvers of the resource. The crowd source access manager identifies a crowd sourced set of users corresponding to the requestor and identifies preferred approvers from the crowd sourced set of users that are also included in the set of candidate approvers. In turn, the crowd source access manager notifies the preferred approvers of the user request.

### TECHNICAL FIELD

The present disclosure relates to crowd sourced access approvals. More particularly, the present disclosure relates to requesting resource access approval from a set of candidate approvers that are included in a requestor's social network or organization group.

### BACKGROUND OF THE INVENTION

Computer networks enable users to access a vast amount of resources such as webpages, files, membership privileges, etc. Some resources are available to the public while other resources require access permissions. In these situations, a user typically requires authorization from a system administrator or authorized personnel to approve access to the resource. For example, a user may be applying for an Institute of Electrical and Electronics Engineers (IEEE) senior membership, which requires approval from three other senior IEEE members.

Recent attacks on establishments such as universities, banks, and other online businesses have increased requirements to gain access to resources. As such, a user's request may require approval from a vice president or a chain of people such as the user's manager, the user's second line manager, the user's director, and the user's vice president. However, if a user submits an access request and one of the approvers in the approval chain is unavailable to approve the request for an extended amount of time, the request may remain unapproved for days, weeks, or even be rejected because the open request exceed an authorization time limit.

### BRIEF SUMMARY

According to one embodiment of the present disclosure, an approach is provided in which a crowd source access manager receives a user request from a requestor to access a resource and determines a set of candidate approvers of the resource. The crowd source access manager identifies a crowd sourced set of users corresponding to the requestor and identifies preferred approvers from the crowd sourced set of users that are also included in the set of candidate approvers. In turn, the crowd source access manager notifies the preferred approvers of the user request.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present disclosure, as defined solely by the claims, will become apparent in the non-limiting detailed description set forth below.

### BRIEF DESCRIPTION OF THE SEVERAL VIEWS OF THE DRAWINGS

The present disclosure may be better understood, and its numerous objects, features, and advantages made apparent to those skilled in the art by referencing the accompanying drawings, wherein:

FIG. 1 depicts an information handling system, which is a simplified example of a computer system capable of performing the computing operations described herein;

FIG. 2 provides an extension of the information handling system environment shown in FIG. 1;

FIG. 3 is a depiction of a system diagram that includes a crowd source manager that determines preferred approvers of a requestor's resource request;

FIG. 4 is a depiction of a diagram showing an intersection of a requestor's crowd sourced set of users and a resource's set of candidate approvers;

FIG. 5 is a depiction of a diagram showing a preferred approver selection based upon an organizational hierarchy;

FIG. 6 is a depiction of a diagram showing a preferred approver selection based upon a social network hierarchy; and

FIG. 7 is a depiction of a flowchart showing steps in sending approval requests to preferred approvers from a subset of users included in a set of candidate approvers and a set of crowd sourced set of users.

### DETAILED DESCRIPTION

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. The following detailed description will generally follow the summary of the disclosure, as set forth above, further explaining and expanding the definitions of the various aspects and embodiments of the disclosure as necessary.

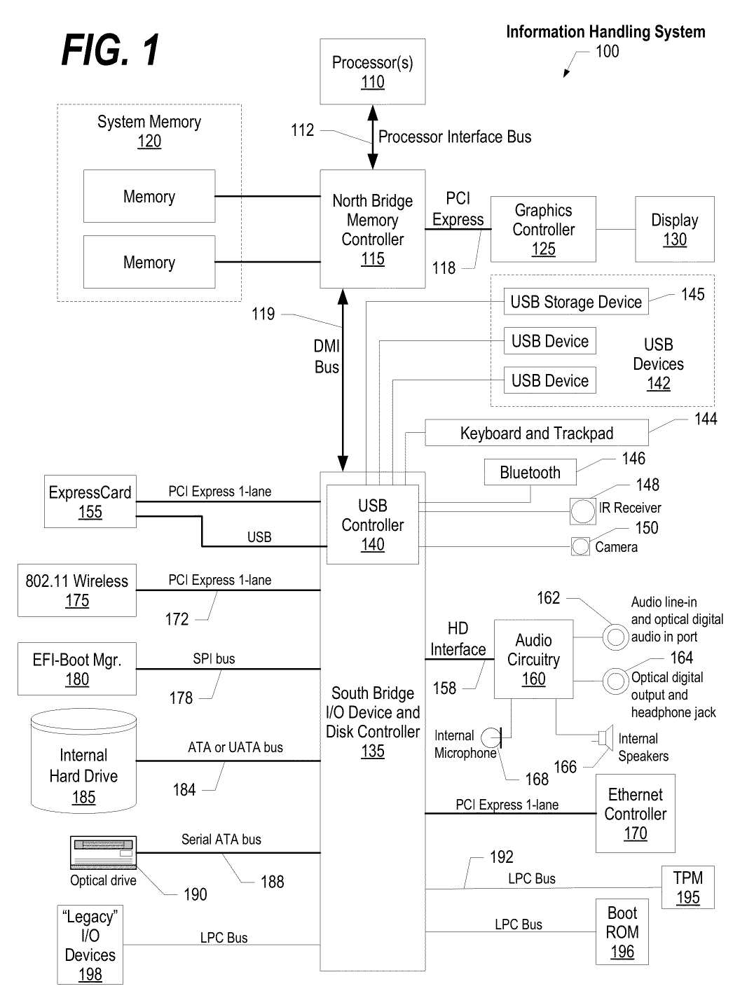

FIG. 1 illustrates information handling system 100, which is a simplified example of a computer system capable of performing the computing operations described herein. Information handling system 100 includes one or more processors 110 coupled to processor interface bus 112. Processor interface bus 112 connects processors 110 to Northbridge 115, which is also known as the Memory Controller Hub (MCH). Northbridge 115 connects to system memory 120 and provides a means for processor(s) 110 to access the system memory. Graphics controller 125 also connects to Northbridge 115. In one embodiment, PCI Express bus 118 connects Northbridge 115 to graphics controller 125. Graphics controller 125 connects to display device 130, such as a computer monitor.

Northbridge 115 and Southbridge 135 connect to each other using bus 119. In one embodiment, the bus is a Direct Media Interface (DMI) bus that transfers data at high speeds in each direction between Northbridge 115 and Southbridge 135. In another embodiment, a Peripheral Component Interconnect (PCI) bus connects the Northbridge and the Southbridge. Southbridge 135, also known as the I/O Controller Hub (ICH) is a chip that generally implements capabilities that operate at slower speeds than the capabilities provided by the Northbridge. Southbridge 135 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 196 and “legacy” I/O devices (using a “super I/O” chip). The “legacy” I/O devices (198) can include, for example, serial and parallel ports, keyboard, mouse, and/or a floppy disk controller. The LPC bus also connects Southbridge 135 to Trusted Platform Module (TPM) 195. Other components often included in Southbridge 135 include a Direct Memory Access (DMA) controller, a Programmable Interrupt Controller (PIC), and a storage device controller, which connects Southbridge 135 to nonvolatile storage device 185, such as a hard disk drive, using bus 184.

ExpressCard 155 is a slot that connects hot-pluggable devices to the information handling system. ExpressCard 155 supports both PCI Express and USB connectivity as it connects to Southbridge 135 using both the Universal Serial Bus (USB) the PCI Express bus. Southbridge 135 includes USB Controller 140 that provides USB connectivity to devices that connect to the USB. These devices include webcam (camera) 150, infrared (IR) receiver 148, keyboard and trackpad 144, and Bluetooth device 146, which provides for wireless personal area networks (PANs). USB Controller 140 also provides USB connectivity to other miscellaneous USB connected devices 142, such as a mouse, removable nonvolatile storage device 145, modems, network cards, ISDN connectors, fax, printers, USB hubs, and many other types of USB connected devices. While removable nonvolatile storage device 145 is shown as a USB-connected device, removable nonvolatile storage device 145 could be connected using a different interface, such as a Firewire interface, etcetera.

Wireless Local Area Network (LAN) device 175 connects to Southbridge 135 via the PCI or PCI Express bus 172. LAN device 175 typically implements one of the IEEE 0.802.11 standards of over-the-air modulation techniques that all use the same protocol to wireless communicate between information handling system 100 and another computer system or device. Optical storage device 190 connects to Southbridge 135 using Serial ATA (SATA) bus 188. Serial ATA adapters and devices communicate over a high-speed serial link. The Serial ATA bus also connects Southbridge 135 to other forms of storage devices, such as hard disk drives. Audio circuitry 160, such as a sound card, connects to Southbridge 135 via bus 158. Audio circuitry 160 also provides functionality such as audio line-in and optical digital audio in port 162, optical digital output and headphone jack 164, internal speakers 166, and internal microphone 168. Ethernet controller 170 connects to Southbridge 135 using a bus, such as the PCI or PCI Express bus. Ethernet controller 170 connects information handling system 100 to a computer network, such as a Local Area Network (LAN), the Internet, and other public and private computer networks.

While FIG. 1 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

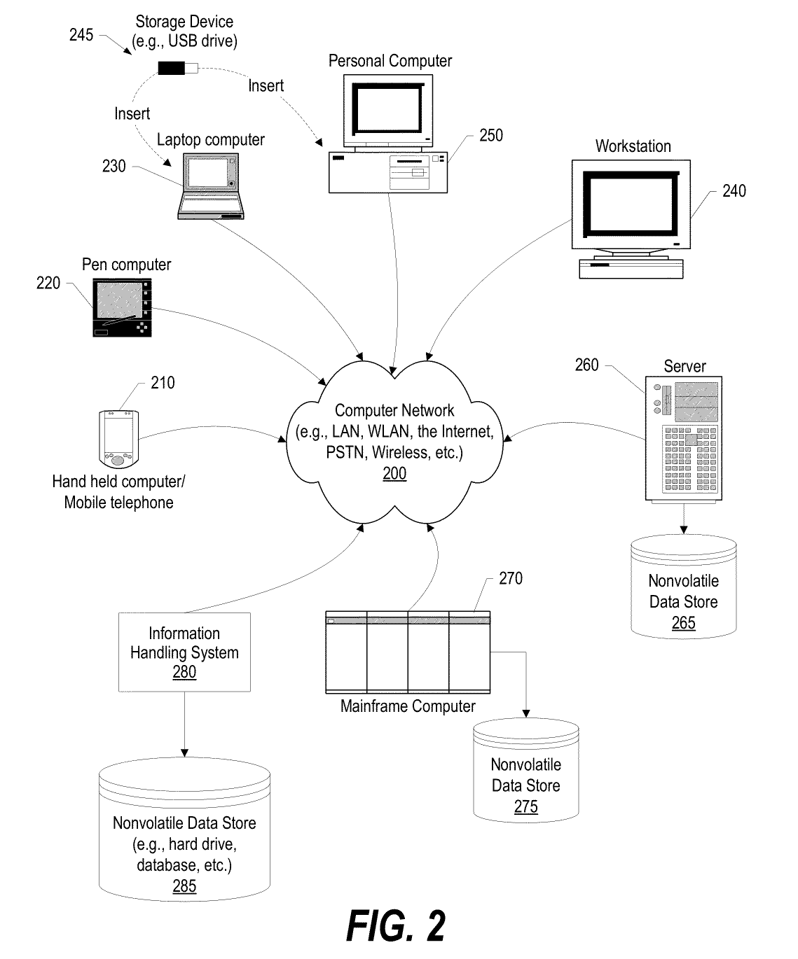

The Trusted Platform Module (TPM 195) shown in FIG. 1 and described herein to provide security functions is but one example of a hardware security module (HSM). Therefore, the TPM described and claimed herein includes any type of HSM including, but not limited to, hardware security devices that conform to the Trusted Computing Groups (TCG) standard, and entitled “Trusted Platform Module (TPM) Specification Version 1.2.” The TPM is a hardware security subsystem that may be incorporated into any number of information handling systems, such as those outlined in FIG. 2.

FIG. 2 provides an extension of the information handling system environment shown in FIG. 1 to illustrate that the methods described herein can be performed on a wide variety of information handling systems that operate in a networked environment. Types of information handling systems range from small handheld devices, such as handheld computer/mobile telephone 210 to large mainframe systems, such as mainframe computer 270. Examples of handheld computer 210 include personal digital assistants (PDAs), personal entertainment devices, such as MP3 players, portable televisions, and compact disc players. Other examples of information handling systems include pen, or tablet, computer 220, laptop, or notebook, computer 230, workstation 240, personal computer system 250, and server 260. Other types of information handling systems that are not individually shown in FIG. 2 are represented by information handling system 280. As shown, the various information handling systems can be networked together using computer network 200. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 2 depicts separate nonvolatile data stores (server 260 utilizes nonvolatile data store 265, mainframe computer 270 utilizes nonvolatile data store 275, and information handling system 280 utilizes nonvolatile data store 285). The nonvolatile data store can be a component that is external to the various information handling systems or can be internal to one of the information handling systems. In addition, removable nonvolatile storage device 145 can be shared among two or more information handling systems using various techniques, such as connecting the removable nonvolatile storage device 145 to a USB port or other connector of the information handling systems.

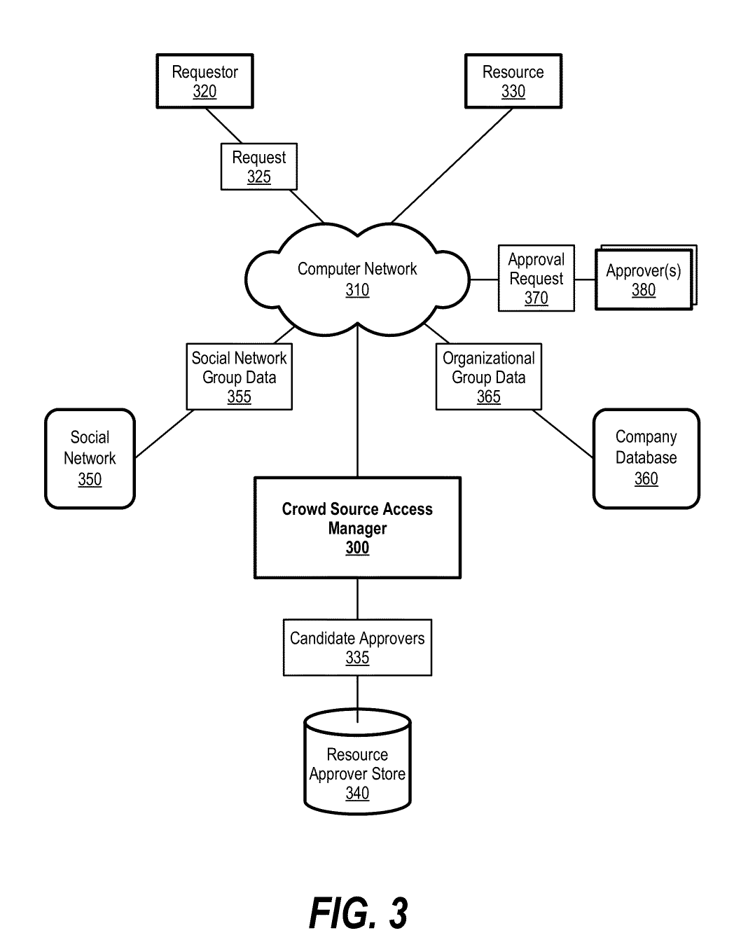

FIGS. 3-7 depict an approach that can be executed on an information handling system, such as one shown in FIG. 1. A system and method of obtaining requestor access approval of a controlled resource through crowd sourcing is presented. A crowd source access manager identifies candidate approvers corresponding to the resource that are authorized to approve the requestor's request, and then identifies a crowd sourced set of users corresponding to the requestor. The crowd sourced set of users may include users included in the requestor's social network group or users included in the user's organizational work group. The crowd source access manager identifies a set of preferred approvers belonging to both the crowd sourced set of users and the set of candidate approvers and, in turn, selects one or more of the set of preferred approvers to approve the requestor's request based on, for example, the requestor's social network hierarchy or the requestor's organizational hierarchy.

FIG. 3 is a depiction of a system diagram that includes a crowd source manager that identifies preferred approvers of a requestor's resource request. Crowd source access manager 300 receives resource request 325 from requestor 320 over computer network 310. Request 325 identifies requestor 320 and a resource in which requestor 320 wishes to access (resource 330). Resource 330 may be, for example, a website, a membership access, a file, a database, or other resource that requires access permission.

Crowd source access manager 300 accesses resource approver store 340 to retrieve candidate approvers 335 that correspond to resource 330. For example, if resource 330 is a company's financial database, candidate approvers 335 may include vice-presidents from the company's finance department.

Crowd source access manager 300 then builds requestor 320's crowd sourced set of users by retrieving social network group data 355 from social network 350 or organizational group data 365 from company database 360. In one embodiment, crowd source access manager 300 obtains requestor 320's social network group data 355 through social network 350's API. In another embodiment, crowd source access manager 300 obtains requestor 320's organizational group data 365 based upon requestor 320's employee ID.

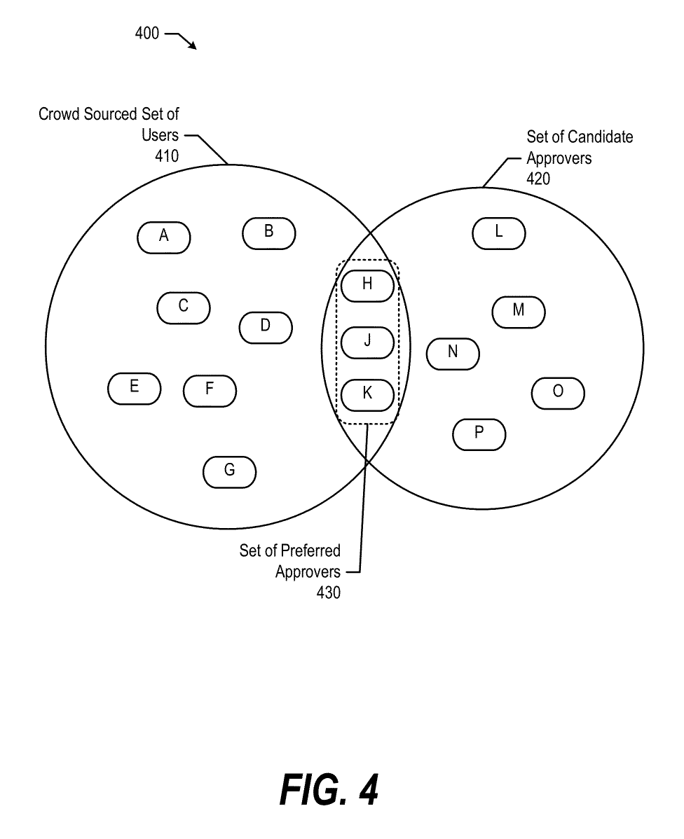

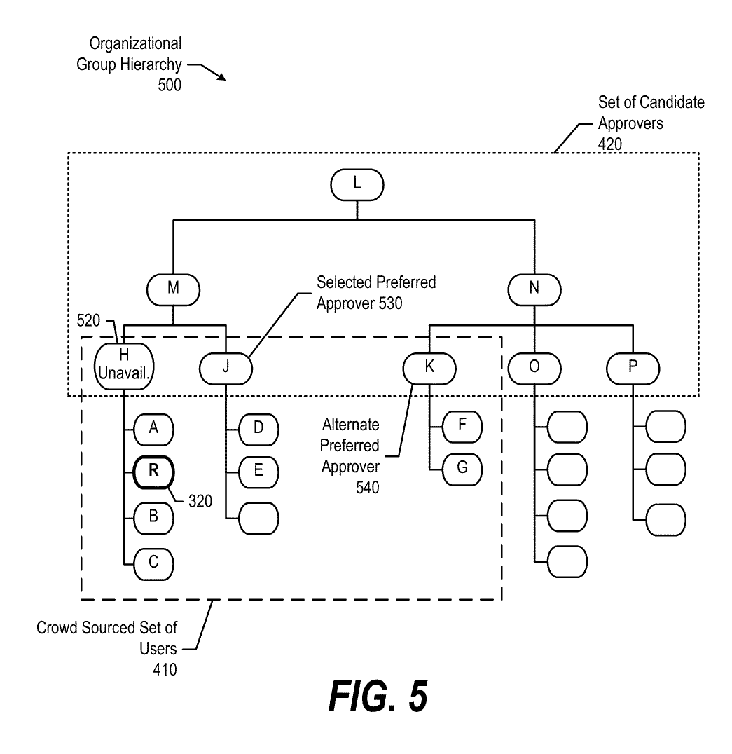

Crowd source access manager 300 then identifies an intersection between the set of candidate approvers and the crowd sourced set of users. In one embodiment, crowd source access manager 300 uses an algorithm to determine the intersecting subset of users that are in both sets, referred to herein as a set of preferred approvers (see FIG. 4 and corresponding text for further details). In turn, crowd source access manager 300 selects a number of preferred approvers based upon the amount required by resource 330 and sends approval request 370 to the selected approvers 380 accordingly. In one embodiment, crowd source access manager 300 selects approvers from the set of preferred approvers based upon a social network hierarchy or an organizational hierarchy (see FIGS. 5-7 and corresponding text for further details).

FIG. 4 is a depiction of a diagram showing an intersection of requestor's crowd sourced set of users and a resource's set of candidate approvers. Diagram 400 includes crowd sourced set of users 410, which includes users A through K that are part of the requestor's social network group and/or organizational group. In one embodiment, the crowd source access manager collects user information from a particular group based upon an authorization hierarchy selection, such as a social network group selection. In another embodiment, the crowd source access manager collects user information from multiple groups. For example, users A through D may be friends of the requestor on a social network site, and users E through K may be work associates. In yet another embodiment, some of the users in crowd sourced set of users may be included in both the requestor's social network group and organizational group.

Diagram 400 includes set of candidate approves 420 that are authorized to grant access to the requested resource, which includes users H through P. Diagram 400 shows the intersection between the two sets, which is a set of preferred approvers 430. Set of preferred approvers 430 includes users H, J, and K, which are users that are authorized to grant access as well have a connection to the requestor. The crowd source access manager selects a number of approvers from set of preferred approvers 430 based upon authorization parameters such as the number of required approvers and the hierarchy selection. For example, a resource may require only one approver based upon a social network hierarchy. In another example, a resource may require three approvers based upon an organizational hierarchy.

FIG. 5 is a depiction of a diagram showing a preferred approver selection based upon an organizational group hierarchy. Organizational group hierarchy 500 organizes users according to a degree of relatedness to requestor 320. User H 520 is requestor 320's direct supervisor, but is unavailable to authorize resource access for reasons such as a vacation, a business trip, etc.

The crowd source access manager maps set of candidate approvers 420 into organizational hierarchy chart 500 and identifies crowd sourced set of users 410 within organizational hierarchy chart 500. The intersection of the two sets of users includes users H, J, and K, which is similar to that shown in FIG. 4. Since user H is unavailable, the preferred approver closest in organizational hierarchy to requestor 320 is user J, which the crowd source access manager selects as preferred approver 530.

In one embodiment, the crowd source access manager selects alternative preferred approver 540 as a backup approver, for example, in case selected preferred approver 530 does not respond to the request within a predetermined timeframe, or when the resource requires multiple approvers to authorize access.

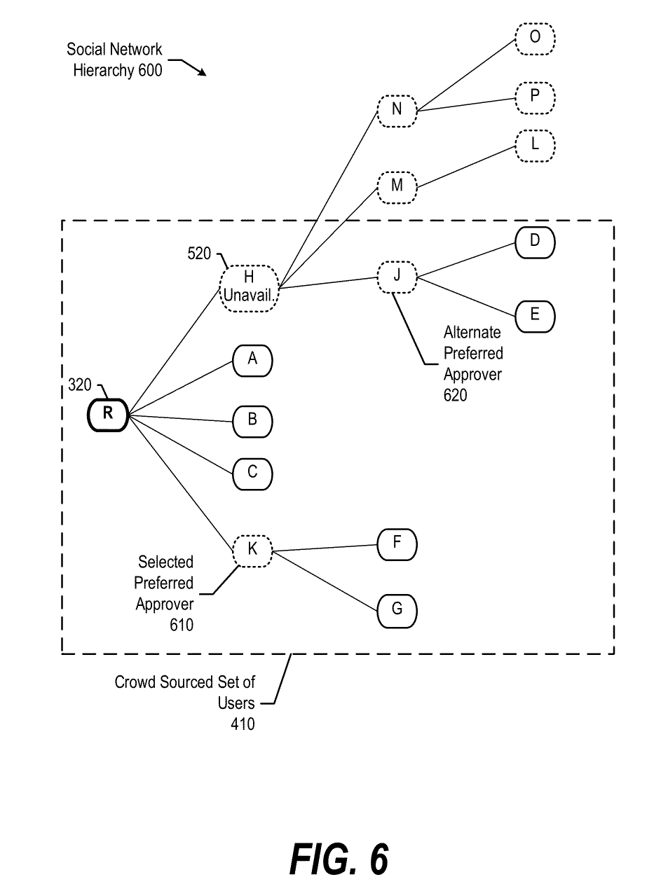

FIG. 6 is a depiction of a diagram showing a preferred approver selection based upon a social network hierarchy. Social network hierarchy 600 organizes users according to a degree of relatedness to requestor 320. Users A, B, C, H, and K are first level friends of requestor 320. Users N, M, J, F, and G are second level friends of requestor 320, and users O, P, L, D, and E are third level friends of requestor 320.

The set of candidate approvers are shown in FIG. 6 with dashed lines, which are users H, K, N, M, J, O, P, and L. Users H 520 and K 610 are requestor 320's first level friend and, because user H is unavailable, the crowd source access manager selects user K 610 as the selected preferred approver. In one embodiment, as discussed above, the crowd source access manager selects alternative preferred approver 620 as a backup approver, for example, in a situation when selected preferred approver 530 does not respond within a predetermined timeframe or when the resource requires more than one approver to authorize access. In another embodiment, the crowd source access manager traverses social network hierarchy 600 to identify users that are at most two levels of closeness away from requestor 320.

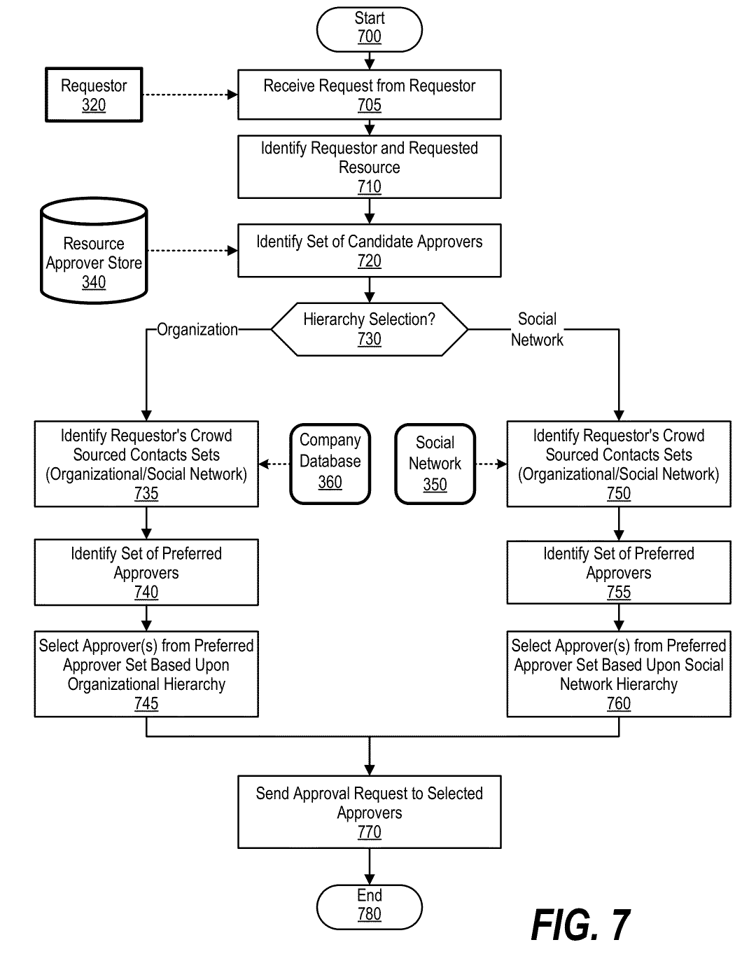

FIG. 7 is a depiction of a flowchart showing steps in sending approval requests to preferred approvers from a subset of users included in a set of candidate approvers and a set of crowd sourced set of users.

Processing commences at 700, whereupon the crowd source access manager receives an access request from requestor 320 at 705. At 710, the crowd source access manager identifies the requestor, such as by a user ID, and the requested resource, which may be a webpage, a file, a database, membership permission, or other type of resource that requires permission to access.

At 720, the crowd source access manager identifies a set of candidate approvers corresponding to the requested resource based upon user information and authorization requirements included in resource approver store 340. For example, the set of authorization requirements may indicate that only vice presidents are authorized to approve access to a sensitive company database.

A determination is made as to whether to select preferred approvers based upon the requestor's organizational group or the requestor's social network group (decision 730). In one embodiment, requestor 320 indicates from which group to select the preferred approvers. In another embodiment, the crowd source access manager is pre-configured to select one of the groups according to, for example, company policies. FIG. 5 shows a preferred approver selection according to an organizational closeness to the requestor.

FIG. 6 shows a preferred approver selection according to a social network closeness to the requestor.

If the approver should be selected from an organizational group, decision 730 branches to the “Organizational” branch, whereupon the crowd source access manager identifies the requestor's crowd sourced set of contacts based upon organizational data retrieved from company database 360 (step 735). At 740, the crowd source access manager identifies a set of preferred approvers by identifying users included in both the crowd sourced set of users and the set of candidate approvers for the resource.

The crowd source access manager selects preferred approver(s) from the preferred approver set based upon an organizational hierarchy, such as that shown in FIG. 5 (step 745). At step 770, the crowd source access manager sends approval requests to the selected approver(s) and processing ends at 780.

On the other hand, If the approver should be selected based upon a social network group, decision 730 branches to the “Social Network” branch, whereupon the crowd source access manager identifies the requestor's crowd sourced set of users based upon social network data retrieved from social network 350 (step 750). At 755, the crowd source access manager identifies a set of preferred approvers by identifying users included in both the crowd sourced set of users and the set of candidate approvers for the resource.

The crowd source access manager selects preferred approver(s) from the preferred approver set based upon a social network hierarchy, such as that shown in FIG. 6 (step 760). At step 770, the crowd source access manager sends approval requests to the selected approver(s) and processing ends at 780.

While particular embodiments of the present disclosure have been shown and described, it will be obvious to those skilled in the art that, based upon the teachings herein, that changes and modifications may be made without departing from this disclosure and its broader aspects. Therefore, the appended claims are to encompass within their scope all such changes and modifications as are within the true spirit and scope of this disclosure. Furthermore, it is to be understood that the disclosure is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to disclosures containing only one such element, even when the same claim includes the introductory phrases “one or more” or “at least one” and indefinite articles such as “a” or “an”; the same holds true for the use in the claims of definite articles.

1. A method implemented by an information handling system that includes a memory and a processor, the method comprising:
determining a set of candidate approvers of a resource in response to receiving a resource request from a requestor to access the resource;
identifying a crowd sourced set of users corresponding to the requestor;
selecting one or more preferred approvers that are included in both the set of candidate approvers and the crowd sourced set of users; and
notifying the one or more preferred approvers of the resource request.

2. The method of claim 1 further comprising:
querying one or more social network applications to identify the crowed sourced set of users.

3. The method of claim 1 further comprising:
performing the selection of the one or more preferred approvers based upon a degree of relatedness to the requestor.

4. The method of claim 3 wherein the degree of relatedness is based on a social network hierarchy corresponding to the requestor.

5. The method of claim 3 wherein the degree of relatedness is based on an organizational group hierarchy corresponding to the requestor.

6. The method of claim 5 further comprising:
selecting a plurality of preferred approvers based upon one or more authorization requirements of the resource, wherein the plurality of preferred approvers are selected according to the organizational group hierarchy and are each included in both the set of candidate approvers and the crowd sourced set of users; and
notifying each of the plurality of preferred approvers of the resource request.

7. The method of claim 1 further comprising:
sending a first notification to a first preferred approver included in the one or more preferred approvers;
selecting a second one of the one or more preferred approvers in response to determining that the first preferred approver has not approved the resource request; and
sending a second notification of the resource request to the second preferred approver.

8. An information handling system comprising:
one or more processors;
a memory coupled to at least one of the one or more processors;
a set of computer program instructions stored in the memory and executed by at least one of the processors in order to perform actions of:
determining a set of candidate approvers of a resource in response to receiving a resource request from a requestor to access the resource;
identifying a crowd sourced set of users corresponding to the requestor;
selecting one or more preferred approvers that are included in both the set of candidate approvers and the crowd sourced set of users; and
notifying the one or more preferred approvers of the resource request.

9. The information handling system of claim 8 wherein the processors perform additional actions comprising:
querying one or more social network applications to identify the crowed sourced set of users.

10. The information handling system of claim 8 wherein the processors perform additional actions comprising:
performing the selection of the one or more preferred approvers based upon a degree of relatedness to the requestor.

11. The information handling system of claim 10 wherein the degree of relatedness is based on a social network hierarchy corresponding to the requestor.

12. The information handling system of claim 10 wherein the degree of relatedness is based on an organizational group hierarchy corresponding to the requestor.

13. The information handling system of claim 12 wherein the processors perform additional actions comprising:
selecting a plurality of preferred approvers based upon one or more authorization requirements of the resource, wherein the plurality of preferred approvers are selected according to the organizational group hierarchy and are each included in both the set of candidate approvers and the crowd sourced set of users; and
notifying each of the plurality of preferred approvers of the resource request.

14. The information handling system of claim 8 wherein the processors perform additional actions comprising:
sending a first notification to a first preferred approver included in the one or more preferred approvers;
selecting a second one of the one or more preferred approvers in response to determining that the first preferred approver has not approved the resource request; and
sending a second notification of the resource request to the second preferred approver.

15. A computer program product stored in a computer readable storage medium, comprising computer program code that, when executed by an information handling system, causes the information handling system to perform actions comprising:
determining a set of candidate approvers of a resource in response to receiving a resource request from a requestor to access the resource;
identifying a crowd sourced set of users corresponding to the requestor;
selecting one or more preferred approvers that are included in both the set of candidate approvers and the crowd sourced set of users; and
notifying the one or more preferred approvers of the resource request.

16. The computer program product of claim 15 wherein the information handling system performs further actions comprising:
querying one or more social network applications to identify the crowed sourced set of users.

17. The computer program product of claim 15 wherein the information handling system performs further actions comprising:
performing the selection of the one or more preferred approvers based upon a degree of relatedness to the requestor.

18. The computer program product of claim 17 wherein the degree of relatedness is based on an organizational group hierarchy corresponding to the requestor.

19. The computer program product of claim 18 wherein the information handling system performs further actions comprising:
selecting a plurality of preferred approvers based upon one or more authorization requirements of the resource, wherein the plurality of preferred approvers are selected according to the organizational group hierarchy and are each included in both the set of candidate approvers and the crowd sourced set of users; and
notifying each of the plurality of preferred approvers of the resource request.

20. The computer program product of claim 15 wherein the information handling system performs further actions comprising:
sending a first notification to a first preferred approver included in the one or more preferred approvers;
selecting a second one of the one or more preferred approvers in response to determining that the first preferred approver has not approved the resource request; and
sending a second notification of the resource request to the second preferred approver.
